(19) United States
(12) Patent Application Publication
(10) Pub. No.: US 2026/0126047 A1
(43) Pub. Date: May 7, 2026

(54) FAN STRUCTURE

(71) Applicant: COOLER MASTER CO., LTD., Taipei City (TW)

(72) Inventor: Jia-Hong SHEN, Taipei City (TW)

(73) Assignee: COOLER MASTER CO., LTD., Taipei City (TW)

(21) Appl. No.: 19/381,937

(22) Filed: Nov. 6, 2025

(30) Foreign Application Priority Data
Nov. 6, 2024 (TW) 113212071

(51) Int. Cl. F04D 25/02; F16H 1/46; F16H 57/02

(52) U.S. Cl. CPC F04D 25/028; F16H 1/46; F16H 57/02; F16H 2057/02073

(57) ABSTRACT

A fan structure includes a housing extending along a first axis, a fan blade rotatably disposed within the housing and along the first axis, and a gear assembly. The gear assembly includes a sun gear coaxially arranged with the fan blade, a ring gear disposed on an inner wall of the housing, a plurality of planet gears meshing between the sun gear and the ring gear, and a decorative plate mounted on the planet gears. When the fan blade is driven to generate airflow, rotation of the fan blade drives the sun gear to rotate, the rotating sun gear causes the planet gears to revolve between the sun gear and the ring gear, and the revolving planet gears drive the decorative plate to rotate.

### CROSS-REFERENCE TO RELATED APPLICATIONS

This U.S. application claims the benefits of priority to Taiwan application No. 113212071, filed on Nov. 6, 2024, titled “Fan Structure” of which is incorporated herein by reference in its entirety.

### BACKGROUND

The advancement of technology has enhanced the performance of electronic products, which generates waste heat. To dissipate the heat produced by electronic products, cooling fans are typically mounted near heat sources to provide airflow for heat dissipation.

However, in general, fans serve only one purpose—cooling. As a result, figuring out how to allow fans to offer more functionality has emerged as a challenge to address.

### SUMMARY

In general terms, this disclosure is directed to a fan structure. In some embodiments, and by non-limiting example, the present disclosure provides a fan structure with distinctive decorative functionality.

Aspects of the present disclosure provide a fan structure. The fan structure includes a housing arranged along a first axis, a fan blade rotatably arranged within the housing along the first axis, and a gear assembly. The gear assembly includes a sun gear coaxially arranged with the fan blade, a ring gear arranged on an inner wall of the housing, a plurality of planet gears meshing between the sun gear and the ring gear, and a decorative plate arranged on the planet gears. Rotation of the fan blade drives the sun gear to rotate, the rotating sun gear drives the planet gears to revolve between the sun gear and the ring gear, and the revolving planet gears drive the decorative plate to rotate.

In some embodiments, the fan structure further includes a transmission gear meshing with the planet gears.

In some embodiments, at least one of the planet gears is dual-layer gears, one layer of each dual-layer gear meshing between the sun gear and the ring gear, and the other layer meshing with the transmission gear.

In some embodiments, the transmission gear is coaxially positioned with the sun gear and rotatably supported by the fan blade.

In some embodiments, the decorative plate is driven by the transmission gear through the planet gears.

In some embodiments, a rotating area of the decorative plate covers a rotating area of the transmission gear.

In some embodiments, the fan structure further includes a lighting element positioned within the housing.

In some embodiments, rotation of the decorative plate defines a circular area.

In some embodiments, the decorative plate is axially arranged on a top side of the housing.

In some embodiments, the decorative plate is coaxially arranged with the fan blade.

In some embodiments, the decorative plate is axially positioned beyond a rotation area of the fan blade.

In some embodiments, the decorative plate is axially positioned opposite to the fan blade.

In some embodiments, a rotating speed ratio of the decorative plate relative to the sun gear is 1:200.

In some embodiments, the sun gear is secured to the fan blade via snap-fit or riveting.

Another aspect of the present disclosure provides a fan assembly. The fan assembly includes a housing, a fan rotor rotatably arranged within the housing, a sun gear coaxially connected to the fan rotor, a ring gear secured relative to the housing, a plurality of planet gears meshing with the sun gear and the ring gear, a transmission gear meshing with the planet gears, and a decorative plate coupled to the transmission gear. Rotation of the fan rotor drives the sun gear to rotate, the rotation of the sun gear propels the planet gears to revolve between the sun gear and the ring gear, the revolving planet gears drive the transmission gear to rotate, and the rotating transmission gear drives the decorative plate to rotate about the first axis.

In some embodiments, the sun gear is connected to the fan blade via snap-fit or riveting.

In some embodiments, at least one of the planet gears is dual-layer gears, one layer of each dual-layer gear meshing between the sun gear and the ring gear, and the other layer meshing with the transmission gear.

In some embodiments, the transmission gear is coaxially arranged with at least one of the sun gear and the fan rotor.

In some embodiments, the fan assembly further includes a lighting element positioned within the housing.

In some embodiments, a rotating speed ratio of the decorative plate relative to the sun gear is 1:200.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 is a bottom view of a fan structure according to embodiments of the present invention.

FIG. 2 is a bottom view of the fan structure, with a decorative plate and a transmission gear omitted.

FIG. 3 is a cross-sectional view of the fan structure, with a first embodiment of the gear assembly.

FIG. 4 is an enlarged partial view of the fan structure of FIG. 3, showing the first embodiment of the gear assembly.

FIG. 5 is a cross-sectional view of a second embodiment of the gear assembly.

FIG. 6 is a bottom view of a fan structure, showing the rotation area of the decorative plate.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

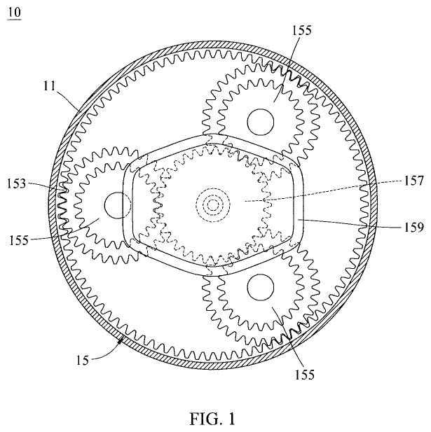

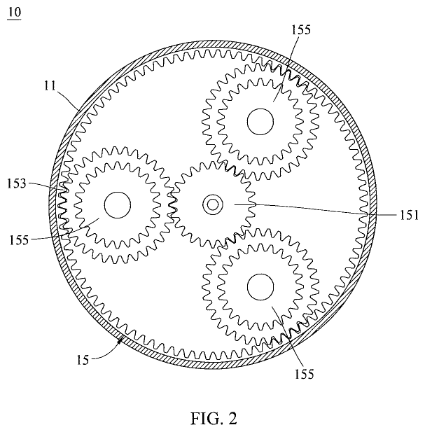

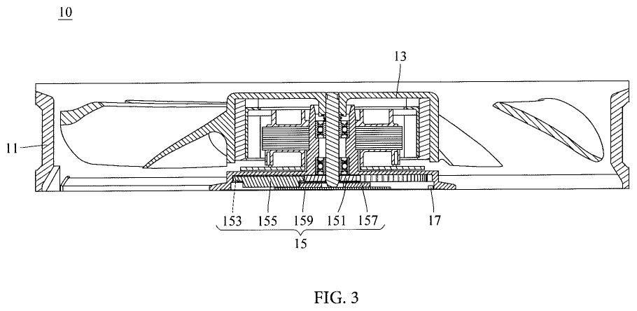

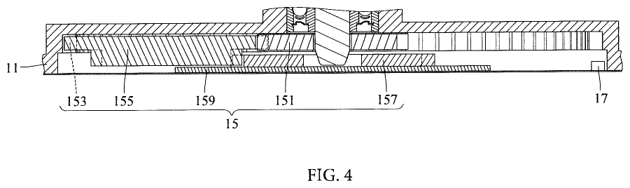

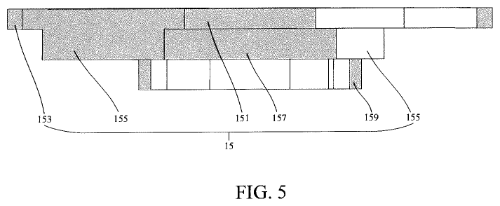

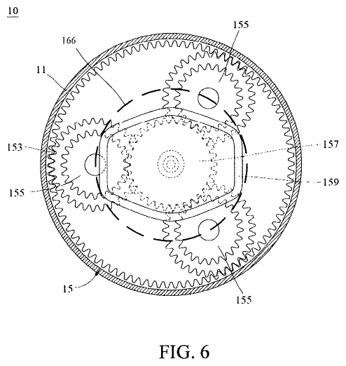

The following describes an embodiment of the present invention with reference to FIGS. 1 to 6. FIG. 1 is a bottom view of a fan structure according to embodiments of the present invention. FIG. 2 is a bottom view of the fan structure, with a decorative plate and a transmission gear omitted. FIG. 3 is a cross-sectional view of the fan structure, with a first embodiment of the gear assembly. FIG. 4 is an enlarged partial view of the fan structure of FIG. 3, showing the first embodiment of the gear assembly. FIG. 5 is a cross-sectional view of a second embodiment of the gear assembly. FIG. 6 is a bottom view of a fan structure, showing the rotation area of the decorative plate.

The fan structure 10 provided in this embodiment comprises a housing 11, a fan blade 13, and a gear assembly 15. The fan blade 13 is rotatably arranged within the housing 11. The gear assembly 15 may include a sun gear 151, a ring gear 153, multiple planet gears 155, a transmission gear 157, and a decorative plate 159.

The sun gear 151 may be coaxially mounted on the fan blade 13 via snap-fit or riveting so that the sun gear 151 rotates together with the fan blade 13. However, the present invention is not limited thereto; in certain embodiments, the sun gear may alternatively be mounted coaxially with the fan blade via adhesive, clips, or other suitable means.

The ring gear 153 is positioned on the inner wall of the housing 11. Alternatively, the housing 11 may include an internal gear portion that forms the ring gear 153.

The planet gears 155 mesh between the sun gear 151 and the ring gear 153 so that when the sun gear 151 rotates, the planet gears 155 revolve around the sun gear 151 and rotate about their own axes. In other embodiments, the planet gears 155 may be divided into two groups: a first group that meshes directly with the sun gear 151 and indirectly with the ring gear 153 via the second group, and a second group that meshes directly with the ring gear 153 and indirectly with the sun gear 151 via the first group. In another embodiment, the planet gears 155 may be divided into three or more groups that mesh sequentially between the sun gear 151 and the ring gear 153.

In some embodiments, each planet gear 155 may be a dual-layer planet gear, as illustrated in the embodiments of FIGS. 1-2 and 5-6. As shown in FIGS. 1-2 and 6, one layer of each dual-layer planet gear meshes directly with the sun gear 151 and the ring gear 153 (e.g., the layer with a larger diameter). Additionally, FIG. 5 presents detailed meshing of the dual-layer planet gear 155. As shown in FIGS. 1 and 5-6, the other layer of each dual-layer planet gear 155 meshes with the transmission gear 157 (e.g., the layer with a smaller diameter), allowing the transmission gear 157 for rotating with the revolution and rotation of the planet gears 155. A rotating axis of the transmission gear 157 may align with that of the sun gear 151, and the transmission gear 157 may be rotatably mounted on the fan blade 13, preserving installation space within the fan structure 10. This all dual-layer arrangement enhances connection stability, allows for smoother torque transmission, and reduces the risk of gear slippage during operation.

In other embodiments, some planet gears 155 may be dual-layer planet gears, while others may be single-layer planet gears, as illustrated in FIGS. 3-4. In these embodiments, three or more planet gears 155 are shown, with only one or two planet gears 155 on the left side of FIGS. 3-4 being dual-layer, and the remaining planet gears 155 on the right side being single-layer. Some planet gears 155 may include only the layer that meshes with the sun gear 151 and the ring gear 153 (e.g., the layer with a larger diameter), while others may include only the layer that meshes with the transmission gear 157 (e.g., the layer with a smaller diameter). This mixed-layer configuration reduces the overall weight of the fan assembly while maintaining sufficient structural stability and reliable torque transfer, balancing performance and cost efficiency.

The decorative plate 159 may feature trademarks, personalized expressions, or other graphic elements. For example, the decorative plate 159 may be attached to the side of the transmission gear 157 opposite the sun gear 151or may be mounted on the planet gears 155 via the transmission gear 157. This allows the decorative plate 159 to rotate together with the transmission gear 157. However, the present invention is not limited thereto. In some embodiments, the transmission gear 157 may be removed, and the decorative plate 159 may be directly coupled to at least two planet gears 155.

When the fan structure 10 operates, the fan blade 13 is propelled to generate airflow, driving the sun gear 151 to rotate alongside the fan blade. The sun gear 151 drives the planet gears 155 to revolve and rotate between the ring gear 153 and the sun gear 151. The dual-layer planet gears 155, in relation to the sun gear 151, drive the transmission gear 157 to rotate, which subsequently propels the decorative plate 159. As a result, the trademarks or personalized graphics on the decorative plate 159 rotate with the operation of the fan structure 10, generating distinctive decorative effects that enhance aesthetic appeal and product recognition.

In this embodiment, the rotating speed ratio of the decorative plate 159 relative to the sun gear 151 can be 1:200 by appropriately selecting the number of teeth on the sun gear 151, ring gear 153, planet gears 155, and transmission gear 157. However, the present invention is not limited thereto. In some embodiments, the number of teeth on each gear may be determined by design criteria in order to achieve a desired speed ratio.

In this and other embodiments, the fan structure 10 may further include a lighting element 17, which may be positioned within the housing 11 to provide lighting effects, further enhancing the aesthetic appeal and recognition of the fan structure 10.

According to the fan structure of the above embodiments, the trademarks or personalized graphics on the decorative plate rotate with the operation of the fan, generating a distinctive decorative effect that increases aesthetic appeal and product recognition.

Furthermore, the lighting element 17 provides illumination to further enhance the aesthetic appeal and recognition of the fan structure.

In some embodiments, the rotating area of the decorative plate 159 is configured to cover the rotating area of the transmission gear 157, as shown in FIG. 5. This arrangement ensures that the decorative plate 159 substantially covers the transmission gear 157 when the fan assembly is in operation, allowing the rotational graphics or logos to remain clearly visible.

In some embodiments, the rotation of the decorative plate 159 defines a rotating area 166, as shown in FIG. 5, and the rotating area 166 may be circular. The circular motion of the decorative plate 159 ensures constant rotation about a first axis (not shown), e.g., a rotating axis of the fan blade 13, a rotating axis of the sun gear 151, a rotating axis of the ring gear 153, or the rotating axis of the transmission gear 157, generating a visually pleasing and consistent decorative effect. In some embodiments, the outermost point of the decorative plate 159 from the rotating center, which is the outer edge of the rotating area 166, crosses across the center of each planet gears 155, as shown in FIG. 5.

In some embodiments, the decorative plate 159 is axially positioned on the top of the housing 11 along the first axis. This axial configuration allows the decorative plate 159 to be clearly displayed above the fan blade 13 and gear assembly 15 while preventing interruption of the airflow generated by the fan blade 13.

In some embodiments, the decorative plate 159 is axially positioned opposite to the fan blade 13 along the first axis. This configuration positions the decorative plate 159 on the side of the gear assembly 15 away from the fan blade 13, providing it more protection while also ensuring safe, unobstructed rotation.

In some embodiments, the decorative plate 159 is coaxially positioned with the fan blade 13 along the first axis. Coaxial alignment ensures that the rotation of the decorative plate 159 is centered and concentric with the fan blade 13, resulting in a balanced rotation and consistent visual presentation.

In some embodiments, the decorative plate 159 is axially positioned beyond the rotating area of the fan blade 13. This axial offset minimizes interference with the fan blade 13 during operation while allowing the decorative plate 159 to rotate freely as driven by the gear assembly 15, reducing visual fatigue when the fan blade rotates faster than the decorative plate 159.

The embodiments illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some number. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces.

What is claimed is:

1. A fan structure, comprising:
a housing arranged along a first axis,
a fan blade rotatably arranged within the housing and along the first axis, and
a gear assembly including:
a sun gear coaxially arranged with the fan blade,
a ring gear arranged on an inner wall of the housing,
a plurality of planet gears meshing between the sun gear and the ring gear, and
a decorative plate arranged on the planet gears,
wherein when the fan blade is driven to generate airflow, the driven fan blade rotates the sun gear, the rotating sun gear drives the planet gears to revolve between the sun gear and the ring gear, and the revolving planet gears drive the decorative plate to rotate.

2. The fan structure of claim 1, further comprising a transmission gear meshing with the planet gears.

3. The fan structure of claim 2, wherein at least one of the planet gears is dual-layer gear, one layer of each dual-layer gear meshing between the sun gear and the ring gear, and the other layer of each dual-layer gear meshing with the transmission gear.

4. The fan structure of claim 2, wherein the transmission gear is coaxially positioned with the sun gear, and the transmission gear is rotatably positioned on the fan blade.

5. The fan structure of claim 2, wherein the decorative plate is driven by the transmission gear through the planet gear.

6. The fan structure of claim 1, wherein a rotating area of the decorative plate covers a rotating area of the transmission gear.

7. The fan structure of claim 1, further comprising a lighting element positioned within the housing.

8. The fan structure of claim 1, wherein the rotation of the decorative plate defines a circular area.

9. The fan structure of claim 1, wherein the decorative plate is axially arranged on the top of the housing.

10. The fan structure of claim 1, wherein the decorative plate is coaxially arranged with the fan blade.

11. The fan structure of claim 1, wherein the decorative plate is axially positioned beyond a rotation area of the fan blade.

12. The fan structure of claim 1, wherein the decorative plate is axially positioned opposite to the fan blade.

13. The fan structure of claim 1, wherein a rotating speed ratio of the decorative plate relative to the sun gear is 1:200.

14. The fan structure of claim 1, wherein the sun gear is secured to the fan blade via snap-fit or riveting.

15. A fan assembly, comprising:
a housing;
a fan rotor rotatably arranged within the housing;
a sun gear coaxially connected to the fan rotor;
a ring gear secured relative to the housing;
a plurality of planet gears meshing with the sun gear and the ring gear;
a transmission gear meshing with the planet gears; and
a decorative plate coupled to the transmission gear,
wherein rotation of the fan rotor drives the sun gear to rotate, the rotation of the sun gear propels the planet gears to revolve between the sun gear and the ring gear, the revolving planet gears drive the transmission gear to rotate, and the rotating transmission gear drives the decorative plate to rotate about the first axis.

16. The fan assembly of claim 15, wherein the sun gear is connected to the fan blade via snap-fit or riveting.

17. The fan assembly of claim 16, wherein at least one of the planet gears is dual-layer gears, one layer of each dual-layer gear meshing between the sun gear and the ring gear, and the other layer of each dual-layer gear meshing with the transmission gear.

18. The fan assembly of claim 16, wherein the transmission gear is coaxially arranged with at least one of the sun gear and the fan rotor.

19. The fan assembly of claim 15, further comprising a lighting element positioned within the housing.

20. The fan assembly of claim 15, wherein a rotating speed ratio of the decorative plate relative to the sun gear is 1:200.
